(19) United States
(12) Patent Application Publication
(10) Pub. No.: US 2024/0142937 A1
(43) Pub. Date: May 2, 2024

(54) METHOD FOR COMMISSIONING A DOOR SYSTEM

(71) Applicants: DORMAKABA DEUTSCHLAND GMBH, Ennepetal (DE); DORMAKABA SCHWEIZ AG, Rümlang (CH); DORMAKABA EAD GMBH, Villingen-Schwennigen (DE)

(72) Inventors: Alexander BRADFISCH, Ennepetal (DE); Christian RAPPEL, Wetzikon (CH); Chandra Prakash GUPTA, Ennepetal (DE); Martin WOLF, Bonn (DE); Stephan GIERNICH, Bonn (DE); Beat KIPFER, Rümlang (CH)

(21) Appl. No.: 18/547,441

(22) PCT Filed: Aug. 19, 2021
(86) PCT No.: PCT/EP2021/073071

§ 371 Date: Aug. 22, 2023

(30) Foreign Application Priority Data
Feb. 24, 2021 (EP) 21382158.0

(51) Int. Cl. G05B 19/406; G06F 8/61

(52) U.S. Cl. CPC G05B 19/406; G06F 8/61; G05B 2219/33297

(57) ABSTRACT

A method for commissioning a door system, with the door system having at least one door component, with the commissioning including the following method step carrying out an electronically defined test process of the door system wherein the test process includes test steps and/or test functions, wherein the sequence of the test steps and/or test functions is stored electronically in the test process, wherein the test process is defined for a preconfigured door system type.

### CROSS-REFERENCE TO RELATED APPLICATIONS

This application is a 35 U.S.C. § 371 National Stage patent application of PCT/EP2021/073071, filed on 19 Aug. 2021, which claims the benefit of European patent application 21382158.0, filed on 24 Feb. 2021, the disclosures of which are incorporated herein by reference in their entirety.

### TECHNICAL FIELD

The disclosure relates to a method for commissioning a door system, with the door system comprising at least one door component.

### BACKGROUND

Door systems according to the prior art typically have a plurality of door components. When a door system is commissioned, the door components are checked for functionality. The test is initiated manually and monitored by an installer. The installer can set e.g. parameters on the door components, e.g. a door drive. Depending on the knowledge of the installer, the commissioning can proceed differently and achieve different results with which the door system goes into operation.

### SUMMARY

The disclosure provides a method, a computer program product, a door system and a door arrangement for commissioning a door system, with which it is ensured that the door components used meet specified criteria and/or which is improved in terms of safety aspects.

This is achieved by providing a method with the features of claim 1. Advantageous further developments of the method are indicated in the dependent claims, the description and in the figures. Features and details that are described in connection with the method according to the disclosure thereby also apply in connection with a computer program product according to the disclosure, a door system according to the disclosure and/or a door arrangement according to the disclosure and vice versa. In particular, placed under protection are a computer program product with which a method according to the disclosure, in particular a method according to one of claims 1 to 14, can be carried out, and/or a door system or a door arrangement, with which a method according to the disclosure, in particular a method according to one of the claims 1 to 14, can be carried out. The door system according to the disclosure and the door arrangement according to the disclosure comprise at least one electronic memory as a computer-readable medium on which the computer program according to the disclosure is stored in an executable manner. In this case, the features mentioned in the description and in the claims may each be essential to the disclosure individually by themselves or in combination. The description additionally characterizes and specifies the disclosure, in particular in connection with the figures.

A method for commissioning a door system is particularly preferred indicated, with the door system comprising at least one door component.

The method comprises at least the step:
a. carrying out an electronically defined test process of the door system.

According to the disclosure, the test process is fixedly predefined since the test process is electronically defined. Thus the knowledge of the installer is less decisive for the success of the test process. As a result, the door system can be set up and verified particularly well and start operation. The door system thus has particularly good security during operation. Compliance with quality standards is ensured by the predefined test process.

In particular, the test process is predefined by software as a computer program product.

The door system according to the disclosure preferably comprises a control unit. The electronic control unit can comprise at least one processor. The electronic control unit can comprise at least one electronic memory.

It may be that the control unit is in an information technology connection with a mobile terminal. Thus, the control unit and the mobile terminal can exchange electronic messages. It is preferably provided that the control unit comprises a transmitting and receiving unit for wireless near-field communication with a mobile terminal. The wireless near-field communication can be e.g. Bluetooth Low Energy (BLE), WIFI or NFC.

It can be provided that the method is carried out at least partially by means of the mobile terminal. The mobile terminal is used in particular by the installer during commissioning. The mobile terminal comprises in particular a display device and/or an input device. The mobile terminal can in particular be a mobile telephone, a tablet or a laptop. The mobile terminal can preferably be connected to a computing unit, in particular a cloud, via remote communication, in particular a telephone network and/or the Internet.

The mobile terminal comprises in particular a processor and/or a memory. Application software (app) can be stored in the memory as a computer program product. The application software can be used in the commissioning method. It is therefore possible that a computer program product is used both in the control unit and in the mobile terminal to carry out the electronically defined test process.

The electronically defined test process can be stored in particular in the electronic memory of the control unit and/or in the memory of the mobile terminal. The electronically defined test process can be carried out in particular by means of the processor of the control unit and/or the mobile terminal.

The door arrangement according to the disclosure comprises the door system according to the disclosure and the mobile terminal. It may be that the door arrangement according to the disclosure comprises the computing unit, in particular a cloud. The computing unit can be connected to the door system, in particular to the control unit, in terms of information technology. For example, the computing unit and the control unit are connected to one another via a bus system, e.g. an IP-enabled bus. The computing unit can be connected to the mobile terminal in terms of information technology, in particular wirelessly. For example, the computing unit and the mobile terminal can be connected to one another via remote communication, e.g. the Internet or a telecommunications connection.

In particular, a plurality of door components that are designed to be arranged on at least one door are referred to as a door system. It may be that different provided door component assemblies each form different door system types.

At least one of the door components serves in particular to change the door state. The change of the door state can correspond e.g. to opening the door, closing the door, unlocking the door, locking the door, providing a state for manually unlocking and/or locking, opening and/or closing the door.

For example, a door component can be designed as a motorized door drive. The motorized door drive can effect a motorized opening and/or closing of the door. In another example, a door component can be designed as an electrically actuatable locking device. The electrically actuatable locking device can unlock and/or lock the door. The locking device can be designed, for example, as e.g. a motor lock, a motorized lock cylinder or an electromagnetic door lock. The motor lock can be a plug-in motor lock. In a further example, a door component can be designed to transfer the door into a manually unlockable state. A door component that can transfer the door into a manually unlockable state is referred to below as an unlocking device. For example, the door component can be designed as an electric door opener. The electric door opener can assume a state in which manual actuation of the door unlocks and simultaneously opens the door, while in another state of the door opener, manual actuation of the door and thus unlocking and opening of the door is prevented. Other examples of providing a state for manually unlocking a door can be seen in an electromechanical lock cylinder and/or an electromechanical fitting.

The door system can comprise at least one door component that generates a signal for changing a door state. A door component of this type is referred to as a signal transmitter. In particular, the signal can cause another door component, e.g. the motorized door drive, the locking device and/or the unlocking device, to change the door state. For example, the signal transmitter can be designed as a sensor that detects a person approaching the door. In another example, the signal transmitter can be designed as a manual button or key switch, which a user actuates to transmit their opening request to the door system. In a further example, the signal transmitter can be designed as a hazard detector, for example a smoke detector. In a further example, the door component can be designed as an authentication device. The authentication device verifies an authorization of the user to go through the door. If the user is authorized, the authentication device sends a corresponding signal to another door component, e.g. to a locking device or an unlocking device, which allows access.

The door system can be designed to receive an access attribute of an authorized user. For this purpose, the door system can comprise a detection unit as a door component or as part of a door component. The detection unit can be designed as a transmitting and receiving unit, as a biometric sensor, as a keypad for inputting a PIN and/or as a contact element for making electrical contact with an in particular electronic key. The access attribute can be designed as a credential or a biometric feature of the user. The credential can comprise e.g. an access code and/or a time window for access authorization. It may be that the door system is designed e.g. as a reader with a transmitting and receiving unit for wirelessly receiving an access attribute, in particular credentials. The transmitting and receiving unit can be designed to communicate with a mobile terminal, in particular a mobile telephone or a card, by near-field communication, in particular RFID, NFC, WIFI or Bluetooth Low Energy. For example, a reader can comprise a detection unit.

It may be that a plurality of functions are implemented in the same door component. For example, an electromechanical fitting can comprise a coupling element that allows manual unlocking of the door in an engaged state. At the same time, the electromechanical fitting comprises a detection unit, in particular a transmitting and receiving unit for wirelessly receiving a credential. In addition, the electromechanical fitting can comprise a processor and a memory, with which the credential is evaluated and access is decided. Thus, the electromechanical fitting acts as an authentication device.

The door system can be designed to be arranged on a door. A door system preferably comprises all door components provided to be arranged on a door. It may be that the door system is designed for single-leaf or double-leaf doors.

The door system can be designed to be arranged on a plurality of doors. For example, the door system can comprise door components for up to four doors. It may be that the doors are sometimes designed with two leaves. A door system preferably comprises all door components provided to be arranged on the plurality of doors.

It is conceivable that the door components interact functionally, in particular form an interlock, for at least a part of the plurality of doors.

It can be preferred that the electronically defined test process comprises carrying out at least one test step. The test step preferably corresponds to an operating step that is carried out by means of the door system when the door system is in operation.

The test step can be designed e.g. as a motorized door opening or a motorized door closure. In this case, the test step is carried out by a motorized door drive, in particular a swing leaf door, sliding door drive and/or revolving door drive. The test step can be designed as motorized door stopping, in particular to avoid a collision with a person.

The test step can be designed, electrically triggered, to close the door by means of a door closer.

The test step can be designed e.g. as an electrically performed door unlocking or an electrically performed door locking. In this case, the test step is carried out in particular by a locking device, e.g. a motor lock or a door lock of an escape route security system.

The test step can be designed e.g. electrically establishing a requirement for manual unlocking and/or locking. In this case, the test step is carried out in particular by an unlocking device.

The test step can be designed e.g. as a visual and/or acoustic display of a state of the door system. The state to be visually and/or acoustically indicated can be, for example, that access authorization is present or denied. The state to be visually and/or acoustically indicated can be, for example, that an alarm state is present, for example due to the detection of smoke or due to the actuation of an emergency button. The state to be visually and/or acoustically indicated can be, for example, that an alarm state is present because the door has been in an open state for too long.

It can be preferred that the door system comprises a plurality of door components, with the electronically defined test process comprising carrying out at least one test function, with the test function comprising a functional interaction of a plurality of door components.

The test function preferably corresponds to an operating function which is carried out by means of the door system when the door system is in operation.

The interaction of a signal transmitter and a door drive is preferably provided for carrying out the test function. For example, a sensor detects that a person is near the door, whereupon the door drive opens the door by motor. In another example, a sensor detects that a person is in the travel path of the door, whereupon the door drive stops the door by motor. In another example, an authentication device determines that a person is authorized, whereupon the door drive opens the door.

The interaction of a signal transmitter and a locking device or an unlocking device is preferably provided for carrying out the test function. For example, an authentication device determines that a person is authorized, whereupon the locking device unlocks the door.

A plurality of door drives can be provided to carry out the test function. For example, the test function can comprise opening a plurality of door leaves, for example on a double-leaf door or on an interlock, in particular one after the other.

A plurality of locking devices can be provided to carry out the test function. For example, a door can be locked by a motor lock and a door lock of an escape route security system. If an authentication device determines that a person is authorized, the motor lock and the door lock can be unlocked electrically.

At least one door drive and one locking device can be provided for carrying out the test function. For example, the motor lock first unlocks the door before the door drive opens the door.

The test function can also require an interaction of three or more door components, e.g. a signal transmitter, one or a plurality of locking devices and a door drive. If an authentication device determines that a person is authorized, the motor lock and the door lock can be unlocked electrically and the door drive can open the door by motor.

The test function and/or the operating function is/are preferably designed at least partially as firmware. For this purpose, the door components can at least partially comprise a processor, with the aid of which the test function and/or the operating function can be carried out.

It may be that the test function comprises a plurality of test steps.

It may be that a test step and/or test function is carried out without the involvement of an installer. This can be provided e.g. if the test step and/or the test function does not comprise a door component that generates a signal to change the door state. A test function can thus be carried out automatically by the door system.

It may be that the test step and/or the test function requires an action by an installer. This can be provided in particular if the test function comprises a door component that generates a signal to change the door state. In this case, a mobile terminal of the installer preferably displays or outputs what action the installer has to perform in order for the test function to be successful. The action may comprise local positioning of the installer, e.g. entering into a detection region of a sensor or recording biometric data for authentication. For example, the action can comprise an actuation of a door component, e.g. manual actuation of an unlocking device, e.g. a door handle, a door knob, a key, or the actuation of an emergency button or a hazard detector. For example, the action can comprise opening and/or closing the door and/or authentication of the installer.

It is preferably provided that the action of the installer corresponds to an action of a user during operation of the door system.

These measures are advantageous with regard to the security of the door system. The test function, in particular the test process, ensures safety and can purposefully ensure the safety of an escape route, safety during a fire, prevent human injury. Additionally or alternatively, security against unauthorized passage can be guaranteed. Due to the fact that the test process, i.e. at least carrying out a test step and/or a test function, is fixedly predefined electronically, a test process that always remains the same can be predefined. This reduces dependency on the knowledge of the installer.

It is preferably provided that the mobile terminal displays or outputs the action that the installer has to perform in order for the test function to be successful in the form of plain text, with the installer in particular being able to make inputs in plain text in the mobile terminal, so that the mobile terminal can, if necessary, instruct a repetition of the action or another action from a test process for testing the door system.

In the present case, the term plain text comprises the forms of information known from the area of “behavior-driven development”. Accordingly, plain text comprises information in a form that is understandable to everyone, with this in particular being independent of the language of the information. Furthermore, this is independent of whether the information is written or spoken. For example, within the meaning of the present disclosure, a program code in a machine language is not regarded as plain text, while a term, sentence component or sentence in German or English is included under the term plain text.

The mentioned features enable an installer to interact particularly easily with the mobile terminal. Furthermore, the susceptibility to errors when testing a door system is reduced. It is thus made possible in a particularly advantageous manner that the door system can also be tested by non-specialized technical personnel.

Alternatively or additionally, it can be provided that the mobile terminal comprises a typeset-based database and/or an AI-based assistance system, through which
a. the mobile terminal (50) translates into plain text actions stored in machine language that the installer has to perform in order for the test function to be successful, and/or
b. the mobile terminal (50) translates into machine language inputs entered by the installer in plain text in order to process them and in particular to carry out a further test step of a test process.

Using a typeset-based database, information can be translated from machine language into plain text and vice versa. Such databases are known from the area of “behavior-driven development” and often work via simple assignment functions that link specific machine commands with a specific plain text. Systems of this type are particularly suitable for avoiding incorrect translations. If a translation is not possible due to the lack of an assignment function, no incorrect and possibly misleading plain text is reproduced or processed. Rather, in such a case, the machine language or the information is left in plain text to avoid errors.

AI-based assistance systems are particularly advantageous in terms of the degree of automation, variability and area of application, but disadvantageous in terms of the susceptibility to errors in translation. Depending on the location and the required security level, an AI-based assistance system can be used or used in conjunction with a typeset-based database system. An AI-based assistance system can process training data, in particular by means of a supervised machine learning engine, in order to gradually reduce the error rate in a translation.

It can particularly preferably be provided that the mobile terminal has a voice processing device, with the output of plain text by the mobile terminal to the installer comprising a voice output and/or the mobile terminal detecting and processing a voice input in plain text by the installer as an input.

Testing by an installer is simplified by a voice output/input provided in addition to the display on a display device, in particular since the installer can work hands-free in various test steps and thereby still be able to exchange information with the mobile terminal. Depending on requirements, each item of information can in particular be displayed at the same time and output as speech, or output only as speech.

It can be preferred if the mobile terminal, for example the display device, displays or outputs a time interval in which the installer has to perform the action.

It may be that the installer has to perform a plurality of actions to carry out the test function or the test process, with the order of the actions being displayed or output to the installer by the mobile terminal. The time intervals for performing the actions are preferably displayed or output to the installer by the mobile terminal.

In particular, it can be provided that the test process comprises a test function. It can be particularly preferred that the test process comprises a plurality of test steps and/or a plurality of test functions. If the test process comprises a plurality of test steps and/or a plurality of test functions, the sequence of the test steps and/or test functions is stored electronically in the test process. In particular, the sequence of the test steps and/or test functions are carried out automatically one after the other and/or in an electronically fixedly predefined order by the door system. These measures further reduce the dependency on the knowledge of the installer. It is thus determined which test functions are to be carried out.

It can be provided that the installer starts the test process, the start of individual test steps and/or the start of individual test functions by way of an input on the mobile terminal. This improves the attention of the installer in relation to carrying out the test process.

It may be that a description of the test step and/or the test function is displayed or output to the installer by the mobile terminal. This informs the installer about the test step and/or the test function. In particular, the installer can monitor the success of the test step and/or the test function.

It can be preferred that the door system comprises a plurality of different door components, with it being possible to verify a functional interaction of the door components by means of the test process. In particular, the door components comprise at least one or a plurality of door drives and/or one or a plurality of locking devices. In this way, interactions, such as how the door system performs during operation, are verified in the test process so that safe functioning during operation is checked.

In particular, the door drives can be designed for sliding, swing leaf or revolving doors. In particular, the locking device can be designed as an electromechanical or as an electromagnetic door lock, in particular an escape route security system, and/or as a motor lock or as a drive lock. In particular, a further door component can be a smoke detector.

In particular, the functional interaction can be an interaction between the door drive and/or escape route security system or on a door drive with a sensor and a locking device.

It can be preferred that the door system comprises a plurality of door components, with a functional interaction of the door components being able to be verified by means of the test process, with the door components being provided to be arranged on a plurality of doors, with a functional interaction of the door components being able to be verified by means of the test process. For example, a plurality of doors can form an interlock or belong to a common building region.

It can be preferred that at least one desired test result is stored in the electronically stored test process.

If at least one desired test result is stored in the electronically stored test process, the result of a test step, a test function or the test process can preferably be determined using a sensor and/or a control device of the door system. The sensor is preferably a sensor that is used during operation of the door system. For example, the sensor can be designed as a door sensor, with the door sensor detecting whether the door is open or closed. For example, the sensor can be designed to detect the locking state of the door, in particular a bolt position or a latch position. The sensor can be designed to measure the opening width of the door, e.g. to detect a rotation angle of the door.

The desired test result is preferably compared electronically with the determined test result. For example, the test function involves unlocking a motor lock and opening the door by motor. After the test function has been carried out, the door sensor is used to electronically determine that the door has been opened. In particular, the test result can be determined automatically, with the desired test result being compared in particular automatically with the determined test result.

The test result for individual test steps and/or test functions can preferably be determined, in particular automatically. For example, in the example, a sensor can first be used to determine that the motor lock has unlocked the door and then the door sensor can be used to determine that the door was opened by motor.

A control device can be designed in particular as a control device of the door drive, hereinafter referred to as drive controller, as a controller of a motor lock and/or as an escape route controller and/or as the control unit. A plurality of control devices are preferably involved in carrying out the test process.

Additionally or alternatively, a test run, a test function or a test step can be concluded positively by means of the mobile terminal, in that the result to be expected is displayed or output by the mobile terminal and confirmed by an input. For example, the application software (app) can be used to verify whether the test run, the test function or the test step has been carried out as intended. To this end, the application software can request a user input from the installer. For example, after a test step, after a test function or after a test run, the application software can display the result to be expected to the installer on the screen and wait for confirmation from the installer as to whether the expected result has been achieved. It may be that the installer has to confirm with a signature, in particular with an electronic signature, that the expected test result has been achieved. It may be that the test result, in particular the test result with the electronic signature, is stored electronically. It can be provided that a plurality of signatures must be provided before the door system starts operation. It may be that a signature from an independent inspector must be provided before the door system starts operation. In particular, the signature of the independent inspector is required if the door system comprises door components for hazardous situations, such as an escape route security system and/or a hazard detector. Starting operation without the provided at least one signature is preferably electronically prevented.

It can be preferred that, if a comparison of the desired test result with the determined test result is negative, a fault is searched for electronically by the door system, in particular by a control unit of the door system. The comparison is evaluated as negative if the expected test result deviates from the determined test result. The determined test result can be determined automatically by the at least one sensor and/or the at least one control device or by the application software after a user input.

In particular, an error can be searched for in an electronic database. The electronic database can comprise a list of possible errors that can belong to the test step, the test function and/or the test process with a negative test outcome. Here, in particular the states of at least one sensor and/or one control device during the test step, the test function and/or the test process are taken into account. In particular, possible errors are linked to the test step, the test function and/or the test process in the database. In particular, possible errors are linked in the database to the state of at least one sensor and/or one control device during the test step, the test function and/or the test process.

It can be preferred that the possible error and/or a possible troubleshooting option is displayed or output by the mobile terminal. The troubleshooting option can comprise e.g. replacing a door component and/or setting a parameter by the installer. The parameter is preferably set on the mobile terminal. The parameters can be e.g. an opening speed of the door, a motorized power curve of a door drive, a hold-open time of the door, an opening width of the door, a closing speed of the door, an unlocking time of a locking device or an unlocking device, a monitoring time until an alarm is triggered with the door open or similar.

It can be provided that the mobile terminal comprises an input option, with the error being transmitted to the computing unit, in particular via the remote connection, by means of the input option. In the computing unit, the error can be viewed by a computing device, so that a planner can input an instruction for eliminating the error, in particular by inputting it into the computing device. The instruction can be displayed or output to the installer in the application software by mobile terminal as a troubleshooting option.

The troubleshooting, in particular according to the suggested troubleshooting option, can be carried out by an input option for setting the parameter that is used for troubleshooting. The input option is provided in particular by the application software on the mobile terminal. In this way, the operability is advantageously established while maintaining safety.

For example, it can be provided that the door speed is reduced by an input on the mobile terminal, e.g. by arrows or bars, if the determined door speed is too high.

It can be preferred that, if the comparison is identified as negative, the completion of the commissioning of the door system is refused, in particular by the control unit or the mobile terminal. A repetition of the test process at the end of the commissioning is preferably only possible by means of the stored test process. Thus, the door system only goes into operation if the electronically defined test process has been successfully completed. These measures further increase the security of the door system.

It can be preferred that, if at least in one first test step and/or in a first test function, in which the comparison of the desired test result with the test result of the test step carried out and/or the test function carried out ends negatively, and in at least one second test step and/or in at least one second test function, in which the comparison of the desired test result with the test result of the test step carried out and/or the test function carried out ends positively, the first test step and/or the first test function is to be repeated. The second test step and/or the second test function is preferably not to be repeated. The electronically stored test process is thus able to skip test functions with a positive test result when the test process is repeated.

In particular, it may be that the result of the successful, positive test process is stored in the door arrangement, in particular in the computing unit, and/or a test process log is created, with the test process log being able to be signed electronically at least by the installer, in particular by the installer and an inspector.

It is preferably provided that the door system can only be put into operation, electronically permitted, if the entire test process has ended with a positive result. In the event of a negative test process, commissioning is preferably prevented electronically.

It can be preferred that the test process is stored in the electronic control unit of the door system and/or the mobile terminal, with the control unit and/or the mobile terminal controlling the test process and/or comprising an in particular wireless interface to the mobile terminal with a screen. The interface can be designed as the transmitting and receiving unit.

In particular, it may be that a computer program product for carrying out the test process is loaded from the computing unit onto the control unit and/or the mobile terminal. Loading preferably takes place onto the control unit via the IP-enabled bus system. Alternatively, the computer program product can be loaded onto the control unit via the application program (app) to carry out the electronic test process. The application program for the mobile terminal can be loaded by the computing unit. The test steps and/or the test functions are particularly preferably controlled by the control unit in accordance with the operating steps and/or the operating functions. It may be that the order of the test steps and/or the test functions in the test process is predefined by the mobile terminal or by the control unit.

In particular, it may be that the test process is defined for a preconfigured door system type. For example, the computing unit comprises a database in which at least one computer program product for carrying out respectively one predefined test process is stored for each preconfigured door system type. By precisely adjusting the test process to a preconfigured door system type, the testing of the door system can be adjusted particularly well to the installed door system.

It may be that a plurality of door components are connected to one another in terms of information technology with the control unit, in particular via at least one bus system. The control unit preferably receives messages via the information technology connection about a behavior and/or a state of the door components that are involved in the test process.

It may be preferred that at least a plurality of the door components that are verified by means of the test process are connected to a first bus system, with the control unit in particular being connected to the first bus system, with the control unit receiving via the first bus system a behavior and/or a state of the door components that are involved in the test process.

The first bus system is designed in particular as a field bus, e.g. as a CAN bus. The bus system that connects the control unit and the computing unit to one another is referred to in particular as the second bus system.

It can be preferred that the door system comprises a plurality of different door components, with it being possible to verify a functional interaction of the door components by means of the test process. The functional interaction corresponds to the cooperation of the door components in the operation of the door system. The door components preferably cooperate by means of firmware, with the firmware being at least partially stored on the control unit and/or with door components that are connected to one another in terms of information technology, in particular to the first bus system, cooperating by means of the firmware. The information technology connection between the door components makes it possible to reproduce even complex test functions and/or operating functions via firmware. The interaction is preferably tested by means of the firmware in the test process.

In a further aspect of the disclosure, a door system is indicated for carrying out the method. The advantages mentioned above in relation to the corresponding configuration of the method are correspondingly associated with the door system. In particular, the correspondingly designed door system can be used to carry out the method. The door system preferably comprises at least the control unit. The door system preferably comprises at least one further door component, preferably a plurality of further door components.

In a further aspect of the disclosure, one or a plurality of computer program products for carrying out the method is indicated, with the one or plurality of computer program products being able to be stored in the door system, in particular in the control unit, and/or in a mobile terminal. The advantages mentioned above in relation to the corresponding configuration of the method are correspondingly associated with the at least one computer program product. To carry out the method, at least one computer program product is preferably stored in the control unit and one computer program product is stored in the mobile terminal. In particular, a correspondingly designed computer program product can be used to carry out the method.

### BRIEF DESCRIPTION OF THE DRAWINGS

Further details and advantages of the disclosure will be explained below on the basis of the exemplary embodiments shown in the figures. Technical features with identical functions are provided here with identical reference numerals in the figures. They show:

FIG. 1 a first exemplary embodiment of a door system according to the disclosure and a door arrangement according to the disclosure,

FIG. 2 a second exemplary embodiment of a door system according to the disclosure and a door arrangement according to the disclosure

FIG. 3 a third exemplary embodiment of a door system according to the disclosure and a door arrangement according to the disclosure and

FIG. 4 a basic flow chart of a method according to the disclosure.

### DETAILED DESCRIPTION OF THE DRAWINGS

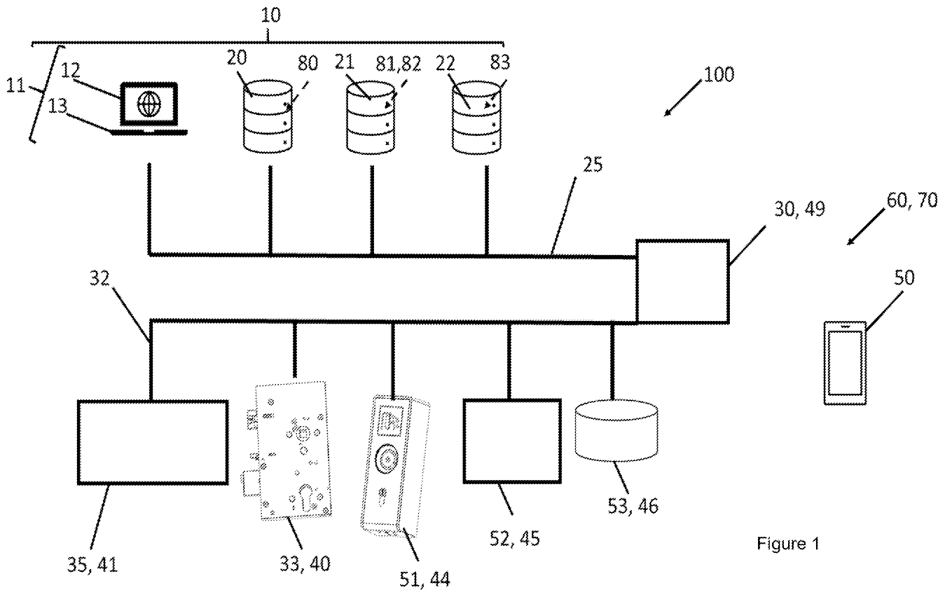

A first exemplary embodiment, a second exemplary embodiment and a third exemplary embodiment of a door system 60, 61, 62 according to the disclosure and a door arrangement 100 according to the disclosure are represented in FIGS. 1 to 3. The door arrangement 100 according to the disclosure comprises a computing unit 10. The computing unit 10 comprises a computing device 11 which is designed as a personal computer. The computing device comprises a screen 12 and a keyboard 13.

The computing unit 10 comprises at least one electronic memory. For example, this can be a memory in a cloud. A first database 20, a second database 21 and a third database 22 are stored in the memory. Alternatively and not represented, the first and the second database 20, 21 can be designed as a common database. The second and third database 21, 22 can also be designed as a common database. In a further alternative, the first and the third database 20, 22 can be designed as a common database. In a further database, the first to third database 20, 21, 22 are integrated in a common database.

Different door systems 60, 61, 62 according to the disclosure are represented in the FIGS. 1 to 3. The doors systems 60, 61, 62 are each part of the door arrangement 100 according to the disclosure. The door systems 60, 61, 62 each comprise a control unit 30 as a first door component. The door systems 60, 61, 62 each comprise a first bus system 32, e.g. a CAN bus.

The door systems 60, 61, 62 comprise further door components. The first door system 60 in FIG. 1 comprises by way of example a motorized door drive 35, a motor lock 33, an escape route controller 51 with an emergency button, an electromagnetic door lock 52 and a hazard detector, in particular a smoke detector 53, as further door components. The door components 35, 33, 51, 52, 53 have different functions and functional properties. Thus, the door components 35, 33, 51, 52, 53 belong to different door component types 40, 41, 44, 45, 46.

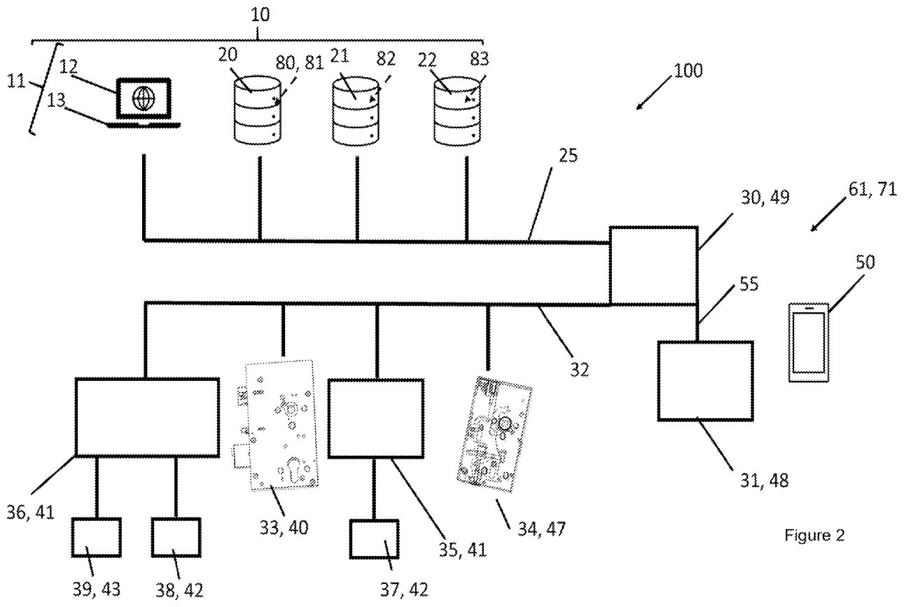

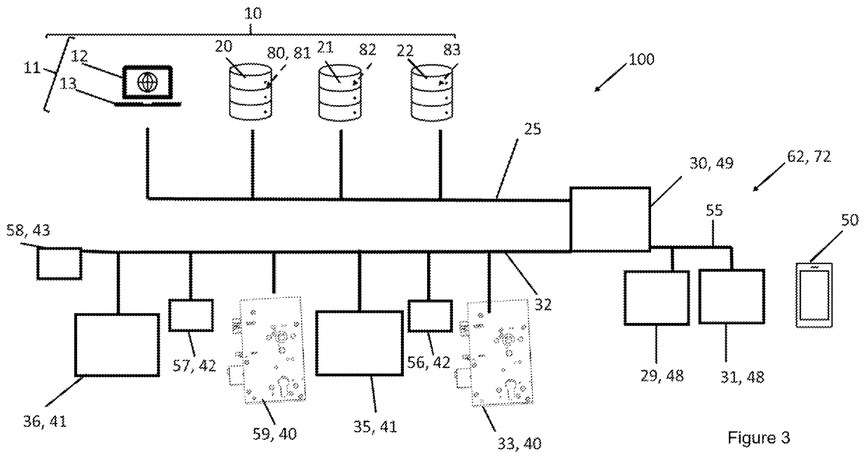

The second door system 61 in FIG. 2 and the third door system 62 in FIG. 3 each comprise a plurality of motorized door drives 35, 36 as door components. The motorized door drives 35, 36 are of identical design and thus belong to the same door component types 41. Furthermore, the second door system 61 and the third door system 62 comprise a plurality of sensors 37, 38 and 56, 57 as door components. The sensors 37, 38 and 56, 57 are used to detect a person approaching the door leaves. The motorized door drives 35, 36 can then open the door leaves in an order predefined in time as a functional process. Additionally or alternatively, the signals of the sensors 37, 38 or 56, 57 are used to stop the door by means of the door drive 35, 36 in order to avoid injury to the person. The sensors 37, 38 and 56, 57 are of identical design and therefore belong to the same door component types 42.

Furthermore, a program switch 39 or 58 is provided as a door component in each case. A user can use the program switch 39, 58 to determine whether or not the sensors 37, 38 or 56, 57 cause a motorized door opening when a person is detected. A program switch 43 is assigned to its own door component type 39.

The door drives 35, 36 of the second door system 61 are designed to each be arranged on a door leaf of a double-leaf door. The second door system 61 comprises a motor lock 34 for an active leaf of the double-leaf door and a motor lock 33 for a passive leaf of the double-leaf door. The motor locks 33, 34 are each assigned to their own door component types 40, 43. A further door component of the second door system 61 is designed as a reader 31 as a further door component type 48. In particular, the reader 31 can communicate wirelessly with a card or a mobile telephone in order to receive an access attribute. An access decision is made by the control unit 30.

The door drives 35, 36 of the third door system 62 are designed to each be arranged on a door leaf of an interlock, each with a single-leaf door. The third door system 62 comprises two motor locks 33, 59 for the active leaf. The motor locks each belong to the same door component type 40. The door system 62 also comprises a plurality of readers 29, 31, with one reader 29, 31 each being provided for arrangement on a door of the interlock.

The door components 33, 35, 51, 52, 53 of the first door system 60 are connected to a first bus system 32. Some door components 33, 34, 35, 36 of the second door system 61 are connected to the first bus system 32. Other door components 37, 38, 39 of the second door system 61 are only indirectly connected to the control unit 30 via a door drive 35, 36. The reader 31 is connected via a third bus system 55, e.g. an RS 485 bus, to the control unit 30.

The door components 30, 33, 35, 36, 56, 57, 58, 59 of the third door system 62 are connected to the first bus system 32. The components 29, 30, 31 are connected via the third bus system 55.

The control unit 30 comprises a transmitting and receiving unit for wireless near-field communication with a mobile terminal 50. The door arrangement according to the disclosure comprises the mobile terminal 50.

Since the first door system 60, the second door system 61 and the third door system 62 comprises different door components, the door systems 60, 61, 62 correspond to different door system types 70, 71, 72.

A door system 60, 61, 62 is characterized in that each door system 60, 61, 62 comprises a common electronic configuration 82. The configuration 82 is designed as at least one electronic file and can be stored on the control unit 30. Exactly one configuration 82 for each type of door system 70, 71, 72 is preferably provided. The databases 20, 21 can be provided for selecting and making available the configuration 82 provided for the door system 60, 61, 62.

A door system 60, 61, 62 each comprises a common control unit 30. The control unit 30 is used to connect to the computing unit 10.

Depending on the door system type 70, 71, 72, a door system 60, 61, 62 can be provided for arrangement on one or on a plurality of doors. In a further exemplary embodiment, not represented, a door system is used, for example, for arrangement on two double-leaf doors arranged one behind the other or on a hotel corridor with four rooms.

It may be that a door arrangement 100 comprises a plurality of door systems 60, 61, 62. The door systems 60, 61, 62 can belong to the same or different door system types 70, 71, 72. The door systems 60, 61, 62 are preferably connected to one another and/or to the computing unit 10 via the second bus system 25.

According to the disclosure, the electronic configuration 82 comprises a test process that can be stored electronically. A test of the door system 60, 61, 62 during the commissioning procedure for each door system type 60, 61, 62 is predefined by means of the test process. Thus, the test process when commissioning a door system 60, 61, 62 of the same door system type 70, 71, 72 is always identical. As a result, commissioning can take place that is largely independent of the knowledge of the installer. As a result, errors in the testing of the door system 60, 61, 62 can be avoided. This results in a particularly safe and predictable operation of the door system 60, 61, 62 after it has been commissioned.

The electronic configuration 82 also comprises a list of components in each case, in which are listed the provided door components of the door system 60, 61, 62 or the provided door components 29, 31, 33, 34, 35, 36, 51, 52, 53, 56, 57, 58 of the door system 60, 61, 62, which are connected to the control unit 30 in terms of information technology. If door components are present multiple times, the list of components thus comprises position information. In the exemplary embodiment of FIG. 2, the position information is “door drive for the active leaf”, “door drive for the passive leaf”. In the exemplary embodiment of FIG. 3, the position information reads “door drive for the first door”, “door drive for the second door”, “sensor for the first door”, “sensor for the second door”, “motor lock for the first door”, “motor lock for the second door”, “reader for the first door” and “reader for the second door”. The control unit 30 can use the list of components to control operating functions via firmware.

The electronic configuration 82 preferably comprises in each case information about which door components connected to the first or third bus system 32, 55 exchange which messages. Thus, the electronic configuration 82 comprises transmitters and receivers of messages. For example, it is provided that the door drive 36 of the door system 61 or the program switch 58 of the door system 62 reports to the control unit 30 in which operating mode the door system 61, 62 is to be operated. The program switch 58 is thus defined as the transmitter and the control unit 30 as the receiver. One operating mode here is an automatic mode in which when a person approaches the door, which is detected by the sensor 37, 38, the door drive 35, 36 associated with the sensor opens the door. Another operating mode is manual operation, in which an approach of a person to the door does not lead to a motorized opening of the door. Rather, the person must authenticate themselves at the reader 31 so that the door is opened or can be opened. The reporting of the program switch 58 to the control unit 30 corresponds to an operating step that is preferably verified as a test step in the test process.

As another example, the electronic configuration 82 specifies that when there is a valid access attribute received by the reader 29 for the first door of the door system 62, the control unit 30 causes the motor lock 33 for the first door to be unlocked. For this purpose, the control unit 30 can send a message to a drive controller of the door drive 35 for the first door, which then actuates the motor lock 33 for the first door. Alternatively, the control unit 30 can send a message to the motor lock 33 for the first door. Thus, the control unit 30 is defined as the transmitter and the drive controller or the motor lock 33 as the receiver in the electronic configuration 82. Sending the message to the drive controller or the motor lock 33 corresponds to an operating step that is preferably verified as a test step in the test process.

The electronic configuration 82 preferably comprises firmware or instructions for the firmware to carry out operating functions. In the case of an operating function, a plurality of messages and/or controls must be carried out one after the other in a defined order. Thus, an operating function comprises a plurality of operating steps. The order is stored in the electronic configuration 82 as firmware or as instructions for the firmware. For example, in manual mode, a person has authenticated themselves by means of a key switch, which is arranged on the escape route controller 51 in FIG. 1. The escape route controller 51 reports the authentication to the control unit 30 and unlocks the door lock 52. The control unit 30 informs the door drive 35 about the unlocking of the door lock 52 and the duration of the unlocking. The drive controller of the door drive 35 then actuates the motor lock 33 for unlocking and, after the motor lock 33 has been unlocked, opens the door by motor. An operating function of this type is preferably verified as a test function in the test process.

The test process preferably comprises a plurality of such test steps and/or test functions. The order is electronically predefined here.

The electronic configuration 82 preferably contains preset parameters for the door system 60, 61, 62, e.g. an unlocking time of the door lock 52 or a hold-open time for the door drive 35, 36.

Since door components 29, 31, 33, 34, 35, 36, 51, 52, 53, 56, 57, 58, 59 of a door system 60, 61, 62 are connected to one another via a first and/or third bus system 32, 55, it is possible to reproduce different operating functions and/or operating functions with a large number of operating steps by means of the firmware. Furthermore, it is easy to adapt the operating functions to changed operating conditions.

Before the start of the test process according to the disclosure, bus addresses of the door components 29, 31, 33, 34, 35, 36, 51, 52, 53, 56, 57, 58, which are connected to the control unit in terms of information technology, i.e. via the first or the third bus system 32, 55, have been stored so as to be assigned to a door component type 40, 41, 42, 43, 44, 45, 46, 47, 48 in the control unit 30. If a plurality of door components 29, 31, 33, 35, 36, 56, 57, 59 of a door component type 40, 41, 42, 48 are present, the bus addresses have been assigned to the door component type and the position information. This allows complex operating functions to be implemented using firmware. The assignment takes place e.g. by an input of the installer on the mobile terminal 50, in particular when a plurality of door components 29, 31, 33, 35, 36, 56, 57, 59 of a door component type 40, 41, 42, 48 are present. For this purpose, the mobile terminal 50 has knowledge of the bus address or an identifier, assigned to the bus address, of the door component 29, 31, 33, 35, 36, 56, 57, 59 to be assigned. The installer can input a position for the bus address or the identifier, which the terminal 50 assigns to the bus address or the identifier and sends to the control unit 50.

It can optionally be provided that the assignment takes place automatically, in particular in the control unit 30, if the door component type 43, 44, 45, 46, 47 is present only once in the door system 60, 61, 62. For this purpose, the door components 29, 31, 33, 34, 35, 36, 51, 52, 53, 56, 57, 58 communicate the respective door component type 40, 41, 42, 43, 44, 45, 46, 47, 48 to the control unit 30. The control unit 30 can then store the bus address assigned to the door component type 40, 41, 42, 43, 44, 45, 46, 47, 48 electronically.

With regard to the first bus system 32, the following assignment method is possible. Each door component 33, 34, 35, 36, 51, 52, 53, 56, 57, 58, 59 connected to the first bus system 32 receives its own bus address from the control unit 30. Each door component 33, 34, 35, 36, 51, 52, 53, 56, 57, 58, 59 of the door system 60, 61, 62 connected to the first bus system 32 sends the control unit 30 the door component type 40, 41, 42, 43, 44, 45, 46, 47 of the respective door component 33, 34, 35, 36, 51, 52, 53, 56, 57, 58, 59. If each door component type 40, 41, 44, 45, 46 is present only once in the door system 60, 61, 62, the control unit 30 thus assigns the bus address to each door component type thus each door component. Thus, when the control unit 30 has to send a message or command to a specific door component, the control unit 30 knows the bus address.

If a plurality of door components 33, 35, 36, 56, 57, 59 of the same door component type 40, 41, 42 are present, then the door components 33, 35, 36, 56, 57, 59 which are present multiple times and are connected to the first bus system 32, are to be assigned to a position. In the door system 61, these are the door drives 35, 36, of which a door drive 35 is in the position “on the passive leaf” and a door drive 36 is in the position “on the active leaf”. Therefore, identifiers of the door drives 35, 36, which is assigned to the bus address, e.g. “Door drive 1” or “Door drive 2”, are displayed to the installer on the mobile terminal 50 after this information has been sent from the control unit to the mobile terminal 50. In addition, at least one of the positions of the door drives 35, 36 “on the passive leaf” and “on the active leaf” is displayed to the installer on the mobile terminal 50.

The installer can now select an identifier, e.g. for the door drive 36. The selected control unit 30 then receives the command from the mobile terminal 50 that the selected door drive 36 has to output a visual and/or acoustic sign. The control unit 30 informs the door drive 36 of the command. The door drive 36 then outputs a visual and/or acoustic sign. For this purpose, the door drive 36 can set a sign by means that the door drive 36 also uses during operation. For example, the door drive 36 can jolt the door or move the door a little. A haptically perceptible sign, e.g. changing a door state by the door component, is possible.

The installer now sees the position at which the selected door drive 36 is arranged, in this case on the active leaf. The installer can input the correct position on the mobile terminal. The mobile terminal 50 transmits the correct position “on the active leaf” and the identifier of the selected door drive 36 to the control unit 30.

The control unit 30 assigns the bus address to each door component whose position has thus become known to the control unit. Alternatively, the control unit 30 transmits the bus addresses to the mobile terminal 50, which carries out the assignment and makes the assignment directly or indirectly available to the control unit 30.

If a particularly secure commissioning method is required, the control unit 30 sends the bus addresses to mobile terminal 50. The installer selects a bus address directly or indirectly, whereupon, as described above, the associated door component outputs a visual and/or acoustic sign. By inputting the position, a provided door component or a provided door component type, the bus address can be assigned to a door component type, a provided door component and/or a position in the mobile terminal 50. The assignment is sent to control unit 30.

In all alternatives, the control unit 30 knows the bus address if the control unit 30 has to send to a specific door component a message or a command to the door drive 35 of the active leaf, but not to the door drive 36 of the passive leaf.

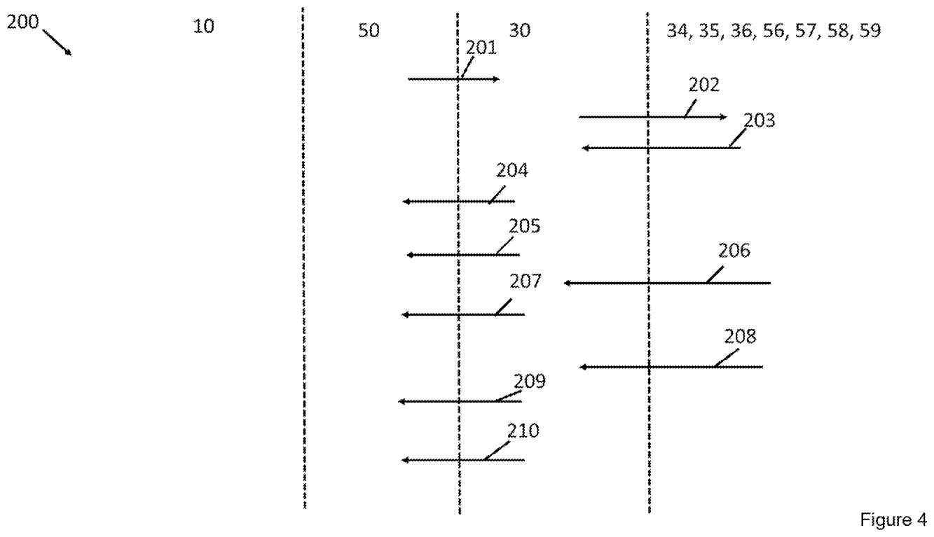

The operating functions reproduced in this way by the firmware are verified by means of the test process 200 by carrying out individual test steps and/or test functions. This is represented in FIG. 4 as an example. The door system 62 of FIG. 3 is referred to here purely by way of example. The columns marked by dashed lines symbolize in which unit or between which units the method step takes place. The first column is assigned to the computing unit 10, the second column to the mobile terminal 50, the third column to the control unit 30 and the fourth column to the other door components 33, 35, 36, 56, 57, 58, 59. The fourth column can thereby require a method step from one of the other door components 34, 35, 36, 56, 57, 58, 59. Communication between the units arranged in the columns takes place via the information technology connection, i.e. the first, the second or the third bus system 32, 25, 55 or the wireless near-field communication.

In a first method step 201, the installer starts the test process by way of an input on the mobile terminal 50. The mobile terminal 50 then sends a corresponding command to the control unit 30. As a result, the control unit 30 carries out the test steps and/or test functions to be checked in the test process in a defined order. In this case, a description of the test step and/or test function is displayed to the installer on the mobile terminal 50 before the test step or test function is carried out. For example, the installer receives the message “Function1: Door 1 will be opened by motor, press here to start”. The installer starts each test step or test function with an input.

In a second method step 202, for example, an operating function is verified in which no action by the installer is required. For example, it is verified whether, when the first door is opened by motor, first the motor lock 59 of the first door is unlocked and then the door drive 36 of the first door opens the first door. For this purpose, the control unit 30 sends a command to the drive controller of the door drive 36, whereupon a drive controller of the door drive 36 first sends an unlocking command to the motor lock 59 and then actuates the door drive 36 of the motor lock.

At the end of carrying out the test function, a door sensor, not represented in FIG. 3, detects whether the first door has been opened. In a step 203, the control unit 30 is notified, in particular via the first bus system, of what the door sensor has detected. If the door has been opened according to the door sensor, the control unit 30 automatically recognizes in step 203 that the test function has been completed successfully. The control unit 30 sends a corresponding message to the mobile terminal 50 in a step 204, whereupon the message “Function 1 completed successfully” is displayed to the installer.

In an alternative embodiment (not represented), the door system 62 does not comprise a door sensor. Rather, at the end of carrying out the test function, a message about the completion of the test function is sent from the control unit 30 to the mobile terminal 50. The mobile terminal 50 then requests an input from the installer about the successful completion of the test function. For example, it is displayed to the installer on the mobile terminal 50: “Function 1 (motorized opening of door 1) successful? Yes/No”. If the installer enters “Yes”, the test function has been completed successfully. If necessary, the installer signs the input with an electronic signature. The mobile terminal 50 sends a corresponding message to the control unit 30.

Now the next operating function is verified. For example, it is verified whether in an automatic mode of the door drive 36 and if the installer is in the detection region of the sensor 57 of the first door, the door drive 36 of the first door automatically opens the door. The mobile terminal 50 informs the installer “Function 2: Door 1: sensory opening, press to start”. Different actions of the installer are defined for carrying out this test function. Thus, in a step 205, the control unit 30 sends the request to the mobile terminal 50 to display the following instruction: “Please set the program switch to automatic”. Optionally, the installer is displayed a time interval in which to set the program switch to automatic. After the time interval has expired and/or after the program switch 58 has reported to the control unit 30 in a step 206 that automatic operation is set, in a step 207 the control unit 30 sends the request to the mobile terminal 50 to display the instruction “Please go to door 1” on the mobile terminal 50. If the first door is then opened by motor, then, analogously to steps 203 and 204, in steps 208 and 209 the operating function is regarded as having been tested successfully.

If, on the other hand, the first door has not opened, which is detected by the door sensor, the control unit 30 determines that the expected test result has not been achieved (not represented). Alternatively, the installer can determine again by inputting into the mobile terminal that the test function was not completed successfully.

The control unit 30 now looks for a source of error. A database is available to control unit 30 for this purpose, or the control unit 30 can make a request to a database of the computing unit 10. For example, the control unit 30 verifies whether the sensor 57 can communicate via the first bus system 32. For this purpose, the control unit 30 sends the request to the sensor 57 to send a sign of life. If the sensor 57 then does not send a sign of life, the control unit 30 sends the request to the mobile terminal 50 to display the following text to the installer. “Function 2: Door 1: sensory opening failed, possible cause: Door 1 sensor inactive, repeat function 2? Yes/No”. This gives the installer the opportunity to rectify the error. Once the error has been rectified, the second function of the test process is repeated. The first function is not verified again.

In a further variant of the method 200 according to the disclosure, the first and/or the second function was regarded as having been tested successfully by the control unit 30 since the first door was opened by means of the door sensor. The installer, on the other hand, is not satisfied because the opening width or opening angle does not match the installation situation. In this case, the option “Change parameters” is displayed on the mobile terminal 50 in addition to the output of the message “Function 2 completed successfully”. By selecting the option, the installer can change the opening width or the opening angle.

In a further variant of the method according to the disclosure, it was determined by means of the drive controller of the door drive 36 that the door could not be opened with the set opening angle. A motor current can be measured for this purpose, for example. The drive controller sends a corresponding message to control unit 30. The control unit 30 regards the test of the second function as having failed and sends a message to the mobile terminal 50 to output the following message: “Function 2: Door 1: sensory opening failed, possible cause: incorrect opening angle, set opening angle?”. In addition, there is a possibility of setting the opening angle on the mobile terminal 50. Once the error has been rectified, the second function of the test process is repeated.

The door system 62 can only be put into operation if the entire test process has ended with a positive result. This takes place in a step 210, with the control unit 30 causing the mobile terminal to display a corresponding message. The successful conclusion of the test process is preferably stored in the third database 22.

It may be that not every operating function is fully simulated by a test function. Thus, the test function can deviate from the operating function. Rather, it can be provided, for example, that the installer triggers an alarm in the case of a smoke detector by actuating an actuating element instead of generating smoke. It may also be that the authentication step is skipped and the control unit 30 assumes a successful authentication in order to test the further steps of the operating function. In a further variant, it can be provided that for functions in which the same reader 31 is involved, the authentication is tested at the reader 31 in a test function, but for other functions in which the same reader 31 is involved, the authentication is skipped, for example when different access attributes trigger different operating functions. For example, a visitor with their access attribute can only open one of the interlock doors at a time, while a firefighter with their access attribute can open both interlock doors at the same time.

It can be provided that test steps are verified in the test process instead of test functions. For example, the first test function can be divided into the test steps “motorized unlocking of the first door” and “motorized opening of the first door”. It may be that the test steps are verified one after the other in the test process. For this purpose, in particular the installer can be displayed the description of the test step on the mobile terminal before the start of a test step. The installer can start the test step with an input. After completion of the test step, it can be determined by sensor or by input from the installer whether the test step was completed successfully.

1. A method for commissioning a door system, wherein the door system has at least one door component, wherein the commissioning comprises the following method step:
a. carrying out an electronically defined test process of the door system wherein the test process comprises a plurality of test steps and/or a plurality of test functions, wherein the sequence of the test steps and/or test functions is stored electronically in the test process, wherein the test process is defined for a preconfigured door system type.

2. The method according to claim 1, wherein the electronically defined test process comprises carrying out at least one test step, wherein the test step corresponds to an operating step which is carried out by the door system during operation of the door system, wherein at least the test step is designed as:
a motorized door opening,
a motorized door closure,
a motorized door stop,
an electrically performed door unlocking,
an electrically performed door lock,
electrically establishing a requirement for manual unlocking and/or locking or
a visual or acoustic indication of a state of the door system.

3. The method according to claim 1, wherein the door system comprises a plurality of door components, wherein the electronically defined test process comprises carrying out at least one test function, wherein the test function comprises a functional interaction of a plurality of door components, wherein the test function corresponds to an operating function that is carried out by the door system during operation of the door system, wherein at least the test function for carrying out the test function comprises the interaction of the following door components:
a signal transmitter and a door drive
a signal transmitter and a locking device
a plurality of door drives
a plurality of locking devices
at least one door drive and at least one locking device.

4. The method according to claim 1, wherein the test function requires an action by a user, wherein it is displayed or output on a mobile terminal of an installer, which action the installer has to perform in order for the test function to be successful, wherein the action comprises a local positioning of the installer, an actuation of a door component, an opening and/or closing of the door and/or an authentication of the installer.

5. The method according to claim 4, wherein the mobile terminal displays or outputs the action that the installer has to perform in order for the test function to be successful in the form of plain text, wherein the installer makes inputs in plain text in the mobile terminal, so that the mobile terminal can, if necessary, instruct a repetition of the action or another action from a test process for testing the door system.

6. The method according to claim 4, wherein the mobile terminal comprises a typeset-based database and/or an AI-based assistance system, through which
a. the mobile terminal translates into plain text actions stored in machine language that the installer has to perform in order for the test function to be successful, and/or
b. the mobile terminal translates into machine language inputs entered by the installer in plain text in order to process them and to carry out a further test step of a test process.

7. The method according to claim 4, wherein the mobile terminal has a voice processing device, wherein the output of plain text by the mobile terminal to the installer comprises a voice output and/or the mobile terminal detects and processes a voice input in plain text by the installer as an input.

8. The method according to claim 1, wherein the mobile terminal displays or outputs a time interval in which the installer has to perform the action and/or wherein the installer has to perform a plurality of actions, wherein the order of the actions and, if necessary, the time intervals for carrying out the actions are displayed or output to the installer by the mobile terminal.

9. (canceled)

10. The method according to claim 1, wherein the door system comprises a plurality of door components, wherein a functional interaction of the door components is configured to be verified by the test process, wherein the door components are provided to be arranged on a plurality of doors and/or the door components are designed differently from one another, wherein a functional interaction of the door components is configured to be verified by the test process.

11. The method according to claim 1, wherein at least one desired test result is stored in the electronically stored test process, wherein the result of a test step, a test function or the test process can be determined using a sensor and/or a control device of the door system, wherein the desired test result is compared electronically with the determined test result and/or a test run, a test function or a test step is positively completed by the mobile terminal in that the result to be expected is displayed or output by the mobile terminal and confirmed by way of an input.

12. The method according to claim 1, wherein, if a comparison of the desired test result with the determined test result is negative, a fault is searched for electronically by the door system, wherein the error and/or a troubleshooting option is displayed or output by the mobile terminal, wherein the troubleshooting option comprises replacing a door component and/or setting a parameter by the installer, wherein the parameter is set on the mobile terminal and/or wherein an immediate input option for setting the parameter that is used for troubleshooting is a troubleshooting option.

13. The method according to claim 8, wherein if a comparison of the desired test result with the determined test result is negative, the completion of the commissioning of the door system is denied, wherein a repetition of the test process at the end of commissioning is only possible by the stored test process and/or wherein, if at least for a first test function, for which the comparison of the desired test result with the test result of the test function carried out is negative, and for at least one second test function, for which the comparison of the desired test result with the test result of the test function carried out is positive, the first test function is to be repeated, wherein the second test function is not to be repeated.

14. The method according to claim 1, that the result of the successful, positive test process is stored in a door arrangement, and/or a test process log is created, wherein the test process log can be electronically signed by the installer and/or by an inspector.

15. The method according to claim 1, wherein the test process is stored in an electronic control unit of the door system and/or in a mobile terminal, wherein the control unit and/or the mobile terminal controls the test process and/or comprises a wireless interface to the mobile terminal.

16. The method according to claim 1, wherein at least a plurality of the door components, which are verified by the test process, are connected to a first bus system, wherein the control unit is connected to the first bus system, wherein the control unit receives via the first bus system a behavior and/or a state of the door components involved in the test process.

17. The method according to claim 1, wherein the door system comprises a plurality of different door components, wherein a functional interaction of the door components can be verified by the test process, wherein the functional interaction corresponds to the cooperation of the door components in the operation of the door system, wherein the cooperation is implemented by firmware, wherein the firmware is stored on the control unit and/or wherein door components connected to the first bus system cooperate by the firmware.

18. A door system and/or door arrangement for carrying out the method according to claim 1.

19. A computer program product for carrying out the method according to claim 1, wherein the at least one computer program product can be stored in the door system.

20. The method according to claim 2, wherein the test process comprises a plurality of test steps, wherein the sequence of the test steps is stored electronically in the test process, wherein the sequence of the plurality of test steps is carried out automatically and/or in a predefined order one after the other.

21. The method according to claim 4, wherein the test process comprises a plurality of test functions, wherein the sequence of the test functions is stored electronically in the test process, wherein the sequence of the test functions is carried out automatically and/or in a predefined order one after the other.
